(19) United States
(12) Patent Application Publication
(10) Pub. No.: US 2008/0081132 A1
(43) Pub. Date: Apr. 3, 2008

(54) Light redirecting film having surface nano-nodules

(76) Inventors: Robert P. Bourdelais, Pittsford, NY (US); Cheryl J. Brickey, Greer, SC (US); Steven M. Pratt, Hilton, NY (US); Steven J. Neerbasch, Rochester, NY (US); Jehuda Greener, Rochester, NY (US)

Correspondence Address: Paul A. Leipold;Patent Legal Staff, Eastman Kodak Company, 343 State Street, Rochester, NY, 14650-2201, US

(21) Appl. No.: 11/393,024

(22) Filed: Mar. 30, 2006

(51) Int. Cl. C09K 19/00

(52) U.S. Cl. 428/1.1

(57) ABSTRACT

A light redirecting optical device comprises a polymeric film containing a light entry and a light exit surface and bearing on the light exit surface convex macrostructures that have a length, diameter, or other major dimension of at least 25 micrometers, wherein a major portion of the macrostructure surfaces is covered with nano-nodules having an average maximum cord length in a plane perpendicular to the direction of light travel of less than 1200 nm

### FIELD OF THE INVENTION

This invention relates to the formation of a light redirecting polymeric film comprising a plurality of nanometer sized integral polymer features. In particular, a light redirecting film having a wide, uniform light output suitable for directing light energy in LCD display devices.

### BACKGROUND OF THE INVENTION

Light redirecting films are typically thin transparent optical films or substrates that redistribute the light passing through the films such that the distribution of the light exiting the films is directed more normal to the surface of the films. Typically, light redirecting films are provided with ordered prismatic grooves, lenticular grooves, or pyramids on the light exit surface of the films which change the angle of the film/air interface for light rays exiting the films and cause the components of the incident light distribution traveling in a plane perpendicular to the refracting surfaces of the grooves to be redistributed in a direction more normal to the surface of the films. Such light redirecting films are used, for example, to improve brightness in liquid crystal displays (LCD), laptop computers, word processors, avionic displays, cell phones, PDAs and the like to make the displays brighter.

Previous light redirecting films suffer from visible Moiré patterns when the light redirecting film is used with a liquid crystal or other display. The surface elements of the light redirecting film interact with other optical films utilized in backlight assemblies, the pattern of printed dots or three-dimensional elements on the back of the light guide plate, or the pixel pattern inside the liquid crystal section of the display to create Moiré, an undesirable effect. Methods known in the art for reducing Moiré have been to die cut the light redirecting films such that the lenticular array is not normal to any side of the sheet. This makes the lenticular array be at an angle relative to another light redirecting film or to the display electronics. Methods also used include randomizing the linear array by widths of the linear array elements, to vary the height along the linear array periodically, to add a diffusing layer on the opposite side of the linear array on the film, or to round the ridges of the linear array. The above techniques to reduce Moiré also cause a decrease in on-axis brightness or do not work to adequately solve the Moiré problem. Moiré and on-axis brightness tend to be related, meaning that a film with high on-axis gain would have high Moiré in a system. It would be beneficial to be able to reduce the Moiré while maintaining sufficient on-axis gain.

In addition, there are relatively few numbers of light redirecting films compared with the-numbers of liquid crystal display configurations. Each display configuration was selected to fill a desired output. The amount of on-axis gain, viewing angle, Moiré reduction, and total light output were all tailored by combining different films in different configurations. The light redirecting film used in the systems is limited because there are only a few different light redirecting surface textures available. It would be desirable to have a light redirecting film that was customizable to the desired output of the display device.

Typical light directing films provide high on-axis illumination at the expense of illumination at angles between 40 and 90 degrees from the normal. These high, on-axis light directing films are useful for portable display devices such as laptop computers and games were a high on-axis brightness lessens the power consumption for batteries and provides for some level of viewing privacy. For some TV and monitor applications that are intended for public viewing, high brightness over a wide range of viewing angles allows for consistent viewing of images and video. It would be desirable to have a light directing film that could provide high brightness over a wide range of viewing angles.

U.S. Pat. No. 5,919,551 (Cobb, Jr. et al) claims a linear array film with variable pitch peaks and/or grooves to reduce the visibility of Moiré interference patterns. The pitch variations can be over groups of adjacent peaks and/or valleys or between adjacent pairs of peaks and/or valleys. While this varying of the pitch of the linear array elements does reduce Moiré, the linear elements of the film still interact with the dot pattern on the backlight light guide and the electronics inside the liquid crystal section of the display.

U.S. Pat. No. 6,354,709 discloses a film with a linear array that varies in height along its ridgeline and the ridgeline also moves side to side. While the film does redirect light and its varying height along the ridgeline slightly reduces Moiré, it would be desirable to have a film that significantly reduces the Moiré of the film when used in a system while maintaining a relatively high on-axis gain.

US application 2001/0053075 (Parker et al.) discloses the use of individual optical elements for the redirecting of light to create high on-axis gain in a LCD device.

U.S. Pat. No. 6,721,102 (Bourdelais et al.) discloses a visible light diffuser formed with complex polymer lenses. The complex lenses disclosed in U.S. Pat. No. 6,721,102 are created by adding micrometer sized polymer lenses on the surface of low aspect ratio polymer base lenses. The ratio of smaller lenses to large lens is between 2:1 to 30:1. The diffuser disclosed in U.S. Pat. No. 6,721,102 is useful for diffusing light sources, in particular, LCD backlight sources.

U.S. Pat. No. 6,583,936 (Kaminsky et al) discloses a patterned roller for the micro-replication of light polymer diffusion lenses. The patterned roller is created by first bead blasting the roller with multiple sized particles, followed by a chroming process that creates micro-nodules. The manufacturing method for the roller is well suited for light diffusion lenses that are intended to diffuse incident light energy.

US Application 2005/00247554 (Epstein et al.) discloses surface structures that are coated with a matrix polymer contain polymer beads preferably having a diameter of between 2 and 5 micrometers to create random scattering.

US Application 2005/0047112 (Chen et al.) discloses a light guide plate with prisms formed on the surface of the light guide plate. The surface of the prisms contain a coated inorganic nano-particle layer consisting of titanium dioxide, silicone dioxide or aluminum oxide to scatter transmitted light.

US Application 2005/0140860 (Olczak) discloses an optical film defined by a first surface structure function modulated by a second surface structure such that the first surface acts to diffuse light incident on the film and the second surface also functions to diffuse incident light.

US Application 2005/0174646 (Cowan et al.) discloses a reflective diffuser, which transmits or reflects incident light into a specific range of angles.

### Problem To Be Solved By The Invention

There is a need to provide a light redirecting film that provides high brightness over a wide range of viewing angles.

### SUMMARY OF THE INVENTION

The invention provides a light redirecting optical device comprising a polymeric film containing a light entry and a light exit surface and bearing on the light exit surface convex macrostructures that have a length, diameter, or other major dimension of at least 25 micrometers, wherein a major portion of the macrostructure surfaces is covered with nano-nodules having an average equivalent circular diameter size less than 1200 nm.

### Advantageous Effect Of The Invention

The invention provides an optical device comprising a light redirecting film having high brightness over a wide range of viewing angles.

### BRIEF DESCRIPTION OF THE DRAWINGS

The invention is best understood from the following detailed description when read with the accompanying drawing figures. It is emphasized that the various features are not necessarily drawn to scale.

FIG. 1 is a magnified top view of a macrostructure in accordance with an example embodiment.

FIG. 2 is a simplified schematic diagram of an apparatus for fabricating optical films in accordance with an example embodiment.

FIG. 3 is a magnified top view of a macrostructure in accordance with an example embodiment.

FIG. 4 is a plot of tilt angle vs. luminance for prior art optical films and a optical film in accordance with an example embodiment.

FIG. 5 is a magnified top view of a macrostructure in accordance with an example embodiment.

### DETAILED DESCRIPTION OF THE INVENTION

The invention has numerous advantages compared to current light redirecting films. The invention provides high on axis brightness over a wide range of viewing angles. This combination of high brightness and wide viewing angles is well suited for the LCD TV and monitor market. High brightness allows for efficient utilization of LCD backlight energy and wide viewing angles ensure even, uniform brightness of the LCD image over a wide range of viewing angles typical of monitors and TV applications. Further, the film provides a softer angular cut-off compared to prior art light directing films. Prior art light directing films have a hard angular cut-off causing illumination to change dramatically over a few degrees. While this hard angular cut-off is acceptable or even preferred for personal viewing devices such as laptop computers, hard angular cut-off can cause a reduction in image quality for LCD devices that are viewed over larger angles such as TV and public view monitors.

The film's individual optical elements' and placement on the film balances the tradeoff between Moiré reduction and on-axis gain producing relatively high on-axis gain while significantly reducing Moiré. Moiré patterns result when two or more regular sets of lines or points overlap. It results in a pattern of repeating lines or shapes, the line size and frequency depending on the two patterns interacting. In a display device such as an LCD display, Moiré patterns that can be observed by the viewer of the LCD device are objectionable as they interfere with the quality of the displayed information or image. The light redirecting film of the invention reduces Moiré compared to prior art light redirecting films while maintaining the amount of on-axis gain. The size and shape distributions of the individual elements and nanometer-sized nodules can be customized for each display or viewing application.

Furthermore, the light redirecting film of the invention can be customized to the light source and light output of the light guide plate in order to more efficiently redirect the light. The individual optical elements make the film very flexible in design parameters, allowing different individual optical elements of different size or orientation to be used throughout the film surface to process the light entering the film the most efficiently. For example, if the light output as a function of angle was known for all points on the light guide plate, a light redirecting film using individual optical elements having different shapes, sizes, or orientation could be designed to efficiently process the light exiting the light guide plate.

Newton rings occur when two reflective surfaces (for example light redirecting films or other optical films in a liquid crystal display) are close enough to each other that the distance starts to approximate the wavelength of light. Photons reflect between the two surfaces as well as passing through them, creating interference effects. Newton rings are undesirable to a viewer through a liquid crystal display. The film of the invention reduces Newton rings by having a percentage of the individual elements extend above other elements on the light redirecting film.

The film of the invention has a larger effective pitch with multiple sized elements than a light redirecting film with only one sized element. Having a larger effective pitch means that film will have higher on-axis gain than the more overlapped film with the same size land, or manufacturing tolerances could be lessened such that the land could become larger to have the same on-axis performance as the more overlapped film. Lessening the manufacturing tolerances could increase productivity of manufacturing the film.

Because the film is a unitary structure of polymer, there are fewer propensities to curl and few losses between layers that differ in refractive index.

When the film is made of two layers, it has a tendency to curl because the two layers typically react differently (expand or contact) to different environmental conditions (for example, heat and humidity). Curl is undesirable for the light redirecting film in an LCD because it causes warping of the film in the display that can be seen through the display. Further, warping of optical films changes the angle of incident light energy causing a loss in optical efficiency. The invention utilizes polymers that resist scratching and abrasion and have been shown to be mechanically tougher compared to other light redirecting films constructed from UV cured polyacrylate.

By adding thin dense chrome to the surface of the metallic macrostructures, it has been found that the mechanical durability of the roller has been improved extending useful roller lifetimes. Further, the nano-nodules allow for efficient release of melted polymer from the roller allowing for more efficient manufacture of the optical film.

Embodiments of the invention may also provide low coefficient of friction surface, reduced dielectric constant, abrasion resistance, increased stiffness, lower scattering, improved Moiré, higher light output and improved coloration. These and other advantages will be apparent from the detailed description below.

The term as used herein, “transparent” means the ability to pass radiation without significant deviation or absorption. For this invention, “transparent” material is defined as a material that has a spectral transmission greater than 90%. The term “light” means visible light. The term “polymeric film” means a film comprising polymers. The term “polymer” means homo-polymers, block co-polymers, co-polymers and polymer blends.

Individual optical elements, in the context of an optical film, mean elements of a well-defined shape that can be projections or depressions in the optical film. Individual optical elements are small relative to the length and width of an optical film. The term “curved surface” is used to indicate a three dimensional element on a film that has curvature in at least one plane. “Wedge shaped elements” is used to indicate an element that includes one or more sloping surfaces, and these surfaces may be combination of planar and curved surfaces. The term “optical film” is used to indicate a thin polymer film that changes the nature of transmitted incident light. For example, a redirecting optical film provides an optical gain (output/input) greater than 1.0. “Optical gain” is defined as output light intensity in a desired direction, usually perpendicular to the film plane, divided by input light intensity. “On-axis gain” is defined as output light intensity perpendicular to the film plane, divided by input light intensity. “Redirecting” is defined as an optical property of an optical film to change the direction on incident light energy.

The term “nano-nodules” or “nanometer sized nodules” means concave and/or convex formations having an average maximum cord length in a plane perpendicular to the direction of light travel of not more than 1200 nm. Nano-nodules are applied over the surface of an optical surface to change the optical output characteristics of the optical surface and are often several magnitudes smaller than the optical surface to which they are applied. Nano-nodules are integral to the optical surface, conveniently having the same composition of the optical surface. The nano-nodules can be of any shape regular or irregular, and are characterized by their maximum cord length in a plane perpendicular to the direction of light travel. The nano-nodules may cover some or the entire optical surface. As an example, on the surface of a 10-micrometer square area of optical surface, there may be between 50 and 200 nano-nodules depending on the size, shape and coverage. Typically, Nano-nodules have a depth or height to/cord length aspect ratio between 0.5 and 5.0.

In order to accomplish a light directing film having high brightness and a wide angular viewing in display devices such as LCD TV, an optical comprising a film bearing convex macrostructures on the light exit surface wherein the macrostructures having a length, diameter, or other major dimension of at least 25 micrometers, a major portion of the macrostructure surfaces being covered with nano-nodules having an average diameter size less than 1200 nm is preferred. By providing a relative large macrostructure greater than at least 25 micrometers in one dimension, the macro-structures will tend to collimate incident light energy by reflecting incident light rays at large angles measured to the normal and allowing light rays on axis or at small angles measured to the normal to be transmitted. It has been shown that by substantially covering the redirecting macrostructures with small nanometer sized nodules the incident light energy is redirected over a wider angle compared to the same redirecting macrostructure with the nano-nodules. Further, the angular brightness cut-off is softer and less abrupt compared to the same redirecting macrostructure with the nano-nodules. In addition, the nano-nodules hide small cosmetic defects in the film, provides a reduction in Moiré compared to light redirecting macrostructures without nano-nodules and better obscures the backlight pattern from the viewer eye compared to light redirecting macrostructures without nano-nodules.

The nano-nodules are small and efficiently reduce the slope of the angular luminance curve off axis compared to prior art diffuser materials that tend to scatter light energy. Scattered light energy in a LCD display will tend to significantly reduce contrast ratio in a liquid crystal cell reducing image quality. By providing nanometer sized nodules on the side of the macrostructures, the nano-nodules widen reduce the slope of the angular luminance curve without unwanted scatter.

On-axis brightness and luminance angles are important determining factors in the contrast ratio of current LCD TV modalities. While increasing on-axis brightness has been shown to improve contrast ratio, angular brightness cut-off is hard. The invention provides a unique combination of high on-axis brightness while providing a soft angular cut-off and a much-improved angular distribution of light that provides excellent image quality to public display devices such as LCD monitors and TV.

Nanometer sized nodules preferably have an average maximum diameter less than 1200 nanometers. Since nano-nodules can be circular, elliptical or irregular in shape cord length is used to measure the size of the nano-nodules. The cord length of a circular nano-nodule is the diameter of the nano-nodule. The cord length of an elliptical element is the major axis. The cord length of an irregular shaped nano-nodule is the maximum length that can be measured on the nano-nodule. For the purposes of this invention, diameter of a nano-nodule can also mean the cord length of the nano-nodule. Average cord length or diameter is an arithmetic average of the maximum cord length or diameter of the nanometer-sized nodules. Average cord length or diameter less than 1200 nanometer provides both high brightness and a wide viewing angle. Nodules' having an average diameter greater than 2000 nanometers reduces the amount of collimation resulting in an unwanted reduction in the overall on-axis brightness and increases light scattering, which tends to reduces desirable contrast ratio.

In another preferred embodiment, the nanometer-sized nodules have an average diameter between 400 and 1200 nanometers, most preferably between 600 and 1000 nanometers. Average sizes below 400 nanometers are below the wave length of visible light and thus are less efficient at diffusing incident light energy and providing a wide viewing angle compared to larger sized nodules. It has been found that nodules sizes between 600 and 1000 nanometers provide an excellent compromise between brightness and viewing angle for the current modalities of LCD TV and monitor devices.

The nano-nodules preferably have a height to width aspect ratio of between 0.5 and 5.0. The size, shape and the distribution of the nano-nodules are important in determining the distribution of light exiting the macrostructures covered by the nano-nodules. Nano-nodules with an aspect ratio less than 0.2 tend to have a small influence on increasing the viewing angle of the macrostructure. Nano-nodules with an aspect ratio of greater than 6.0 are difficult to form utilizing melted polymer cast against patterned metallic roller, as the polymer tends to adhere to the surface of high aspect ratio features. Further, high mechanical pressure is required to fully form the high aspect ratio features, significantly reducing tool life.

In a preferred embodiment of the invention, the nano-nodules have a concave shape relative to the macrostructure. A concave shaped nano-nodule is a depression into the surface of the macrostructure. A concave shaped nano-nodule is preferred because the optically active surface of the nano-nodule is the below the surface of the macrostructure providing protection from undesirable scratching, abrasion and handling damage.

In another preferred embodiment of the invention, the nano-nodules have a convex shape relative to the macrostructure. A convex shaped nano-nodule is a protrusion from the surface of the macrostructure. A convex shaped nano-nodule is preferred because the nano-nodule can be utilized to provide optical standoff from adjacent optical film that might be utilized in combination with the film of the invention. Optical standoff allows reduces undesirable optical coupling between two or more films that would reduce the overall amount of collimation. Further, the nano-nodules have been shown to provide a “ball bearing” type of surface significantly reducing the coefficient of friction between the film of the invention and adjacent films. This reduction in coefficient of friction has been shown to reduce the amount of macrostructure damage caused during film manufacturing and handing during assembly. In further embodiment of the invention, the nano-nodules may be both convex and concave shaped relative to the surface of the macrostructure. By having both shapes present on the surface of the macrostructure, the advantages of the convex and concave nodules can be realized in a single film.

The nano-nodules preferably cover a major portion of the macrostructure. A major portion of the macrostructure is defined as greater than 65% of the total surface area of the macrostructure. Below, 40% coverage, the desired wide viewing angles are difficult to achieve utilizing nano-nodules. The nano-nodules may be uniformly applied to the surface of the macrostructures or may be distributed in a pattern to further customize the light output from the optical film of the invention. For some applications, it is also preferred to provide nano-nodules a single surface of a macrostructure have at least two surfaces. By providing nano-nodules on just one surface, the optical output can be asymmetrical for display applications requiring asymmetrical output such as automobile displays and airport monitors.

In one embodiment of the invention, the macrostructures are preferably structures having a length, diameter or other major dimension of at least 25 micrometers that collimate incident light energy. In one embodiment of the invention, the macrostructure preferably comprises a prism. Prism structures have been shown to be efficient collimators of light and generally have two sloping surfaces that contain the nano-nodules. Light collimation generally is maximized when the included angle of the prism is between 88 and 92 degrees. In another preferred embodiment of the invention, the macrostructures comprise individual optical elements having a ridgeline. Individual optical elements have been shown to reduce Moiré and improve brightness uniformity compared to regular prismatic structures.

The depths of the macrostructures are preferably between 10 and 50 micrometers. The depth of the curved macrostructures is measured from the ridge of the curved macrostructures to the base of the curved macrostructures. A depth less than 8 micrometers results in a redirecting film with low brightness. A depth greater than 55 micrometers is difficult to manufacture and contains features large enough to create a Moiré pattern.

In a preferred embodiment, the macrostructures preferably have a width of between 20 and 100 micrometers. When the macrostructures have a width of greater than 130 micrometers, they become large enough that the viewer can see them through the liquid crystal display, detracting from the quality of the display. When the macrostructures have a width of less than 12 micrometers, the width of the ridgeline of the feature takes up a larger portion of the width of the feature. This ridgeline is typically flattened and does not have the same light shaping characteristics of the rest of the macrostructures. This increase in amount of width of the ridgeline to the width of the macrostructures decreases the performance of the optical film. More preferably, the curved macrostructures have a width of between 15 and 60 micrometers. It has been shown that this range provides good light shaping characteristics and cannot be seen by the viewer through a display. The specific width used in a display device design will depend, in part, on the pixel pitch of the liquid crystal display. The element width should be chosen to help minimize Moiré interference.

The length of the macrostructures as measured along the protruding ridge is preferably between 800 and 3000 micrometers. As the long dimension lengthens the pattern becomes one-dimensional and a Moiré pattern can develop. As the pattern is shortened the screen gain is reduced and therefore is not of interest. This range of length of the curved macrostructures has been found to reduce unwanted Moiré patterns and simultaneously provide high on-axis brightness.

In another preferred embodiment, the macrostructures as measured along the protruding ridge is preferably between 100 and 600 micrometers. As the long dimension of the macrostructures is reduced, the tendency to form Moiré patterns is also reduced. This range of macrostructures length has been shown to significantly reduce unwanted Moiré patterns encountered in display devices while providing on-axis brightness.

The macrostructures of the invention are preferably overlapping. By overlapping the curved macrostructures, Moiré beneficial reduction was observed. Preferably, the curved macrostructures of the invention are randomly placed and parallel to each other. This causes the ridges to be generally aligned in the same direction. It is preferred to have generally oriented ridgelines so that the film collimates more in one direction than the other which creates higher on-axis gain when used in a liquid crystal backlighting system. The curved macrostructures are preferably randomized in such a way as to eliminate any interference with the pixel spacing of a liquid crystal display. This randomization can include the size, shape, position, depth, orientation, angle or density of the optical elements. This eliminates the need for diffuser layers to defeat Moiré and similar effects.

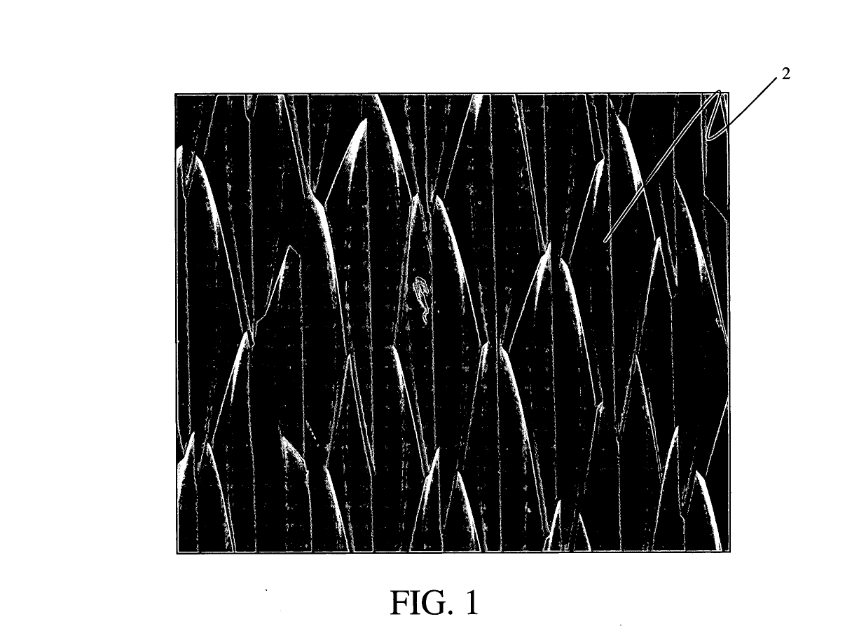

FIG. 1 is a top magnified view of a preferred macrostructure. FIG. 1 contains numerous individual macrostructures that contain a 90-degree apex angle and have a curved face. The individual elements are both overlapping and intersecting and provide a reduction in Moiré compared to ordered macrostructures. The macrostructures in FIG. 1 have been shown to be efficient collimators of incident light energy and can be utilized to improve on-axis brightness in LCD displays.

At least some of the macrostructures may be arranged in groupings across the exit surface of the films, with at least some of the optical elements in each of the groupings having a different size or shape characteristic that collectively produce an average size or shape characteristic for each of the groupings that varies across the films to obtain average characteristic values beyond machining tolerances for any single optical element and to defeat Moiré and interference effects with the pixel spacing of a liquid crystal display. In addition, at least some of the macrostructures may be oriented at different angles relative to each other for customizing the ability of the films to reorient/redirect light along two different axes. It is important to the gain performance of the films to avoid planar, un-faceted surface areas when randomizing features. Algorithms exist for pseudo-random placement of these features that avoid un-faceted or planar areas.

In one embodiment of the invention, the macrostructures preferably have a cross section indicating a 90 degree included angle at the highest point of the feature. It has been shown that a 90 degree peak angle produces the highest on-axis brightness for the light redirecting film. The 90 degree angle has some latitude to it, it has been found that an angle of 88 to 92 degrees produces similar results and can be used with little to no loss in on-axis brightness. When the angle of the peak is less than 85 degrees or more than 95 degrees, the on-axis brightness for the light redirecting film decreases. Because the included angle is preferably 90 degrees and the width is preferably 15 to 30 micrometers, the curved wedge shaped features preferably have a maximum ridge height of the feature of between 7 and 30 micrometers. It has been shown that this range of heights of the wedge shaped elements provide high on-axis gain and Moiré reduction.

In another embodiment of the invention, the apex width preferably is greater than 90 and less than 130 degrees. It has been found that apex widths greater than 90 degrees and less than 130 degrees provide a softer-cut off than apex angles between 88 and 92 degrees. Further, it has also been found that nano-nodule growth on angles greater than 90 degrees yields a narrower size and shape distribution with increases the uniformity of the optical film.

The macrostructures have an average pitch of between 10 and 55 micrometers. The average pitch is the average of the distance between the highest points of two adjacent features. The average pitch is different than the width of the features because the features vary in dimension and they are overlapping, intersecting, and randomly placed on the surface of the film to reduce Moiré and to ensure that there is no un-patterned area on the film. It is preferred to have less than 0.1% un-patterned area on the film, because un-patterned area does not have the same optical performance as the wedge shaped elements, leading to a decrease in performance.

Preferably, the film of the invention has an on-axis gain of between 1.15 and 1.30. The light redirecting film of the invention balances high on-axis gain with reduced Moiré and wide viewing angle. It has been shown that an on-axis gain of at least 1.10 is preferred by LCD manufacturers to significantly increase the brightness of the display. An on-axis gain greater than 1.35, while providing high gain on axis, has a very limited viewing angle. Furthermore, an on-axis gain greater than 1.30 provided by the macrostructures and nano-nodules causes a high degree of recycling in a typical LCD backlight resulting in an overall loss in output light as light recycling in a LCD backlight has loss due to absorption, unwanted reflection and light leaking out the sides of a typical LCD backlight unit. Further, optical films having an optical gain less than 1.10 can be successfully obtained utilizing light diffusers known in the art. Optical films having an optical gain greater than 1.35 can be obtained by utilizing light collimation film known in the art. The invention is a combination of the desirable properties of both a light diffuser and a light collimation film providing high brightness over a wider range of viewing angles.

The nano-nodules preferably are integral to the macrostructure. Integral nano-nodules are preferred because they are optically coupled into the macrostructure improving optical film efficiency compared to nano-nodules that are not integral. Further, integral nano-nodules have been shown to be very durable and avoid deformation and dislocation compared to nano-nodules that have been coated onto the surface of the macrostructure.

The nano-nodules preferably comprise polymer. Polymers are preferred because polymers tend to have a low cost compared to inorganic material, have a high light transmission, can be melt processed and have excellent replication fidelity necessary for nanometer sized objects. In one embodiment of the invention, the nano-nodules comprise an olefin-repeating unit. Polyolefin polymers are low in cost and high in light transmission. Further, polyolefin polymers are efficiently melt-extrudable and therefore can be used to create nano-nodules in roll form.

In another embodiment of the invention, the nano-nodules comprise a carbonate repeating unit. Polycarbonates have high optical transmission values that allows for high light transmission and diffusion. High light transmission provides for a brighter LC device than diffusion materials that have low light transmission values. Further polycarbonates have relatively high Tg suitable for LCD display applications. In further embodiment of the invention, the nano-nodules comprise a ester repeating unit. Polyesters are low in cost and have good strength and surface properties. Further, polyester polymer is dimensionally stable at temperatures between 80 and 200 degrees C. and therefore can withstand the heat generated by display light sources.

In another embodiment of the invention, the nano-nodules comprise a tri-acetyl cellulose or cyclic-olefin polymer. Tri acetyl cellulose and cyclic-olefin has both high optical transmission and low optical birefringence allowing the diffuser of the invention to both diffuse light and preserve native polarization state of light.

The nano-nodules of the invention preferably are randomly distributed over the surface of the macrostructures and the diameter of the individual nano-nodules overlaps by at least 5%. Random placement of the nano-nodules over the surface of the macrostructures preferred because a random pattern of nano-nodules tends to reduce Moiré and is less prone to visual patterns that could arise if the nano-nodules were ordered. It has been found that the human eye can detect size or distribution changes in sub-micro patterns. By randomizing the placement of the nano-nodules, the control of sizes and distribution patterns is less important increasing the manufacturing yield and reducing visual defects. Because the placement of the nano-nodules is random, the probability of some overlap is high. The diameter of the individual nano-nodules preferably overlaps by at least 5%. Further, in order to reduce the amount of macrostructure surface area not covered by the nano-nodules, some amount of overlap is required, especially when the nano-nodules are circular or elliptically shaped.

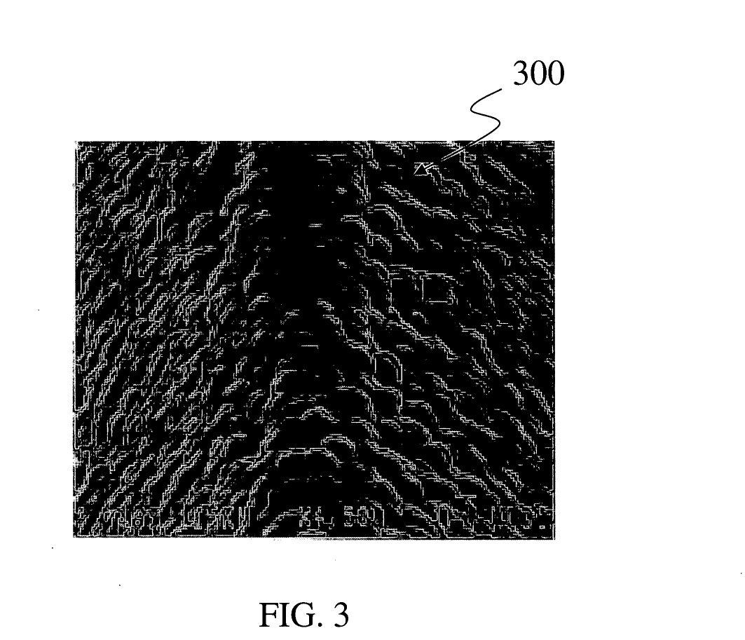

FIG. 3 is a top magnified view of a 90 degree apex angle macrostructure containing nanometer sized nodules which serve to widen the luminance ½ angle compared to a macrostructure with smooth side walls. The convex nano-nodules in FIG. 3 are roughly distributed over 95% of the surface of the macrostructure very few of the nano-nodules overlap and intersect. The nano-nodules are integral to the macrostructure in FIG. 3 and are made of the same material. Because the nano-nodules are integral, they have excellent adhesion reducing the probability that the nano-nodules will separate from the macrostructure. Also, because the nano-nodules are integral to the macrostructure transmitted light energy is optically coupled into the nano-nodules eliminating unwanted scatter or reflection that would reduce the efficiency of the optical film. The nano-nodules in FIG. 3 are convex nodules and tend to be roughly elliptical in shape. The Ra of the nano-nodules 300 in FIG. 3 is 925 nanometers and the nano-nodules in FIG. 3 have a measured mean diameter of 1.08 micrometers. The nano-nodules in FIG. 3 are distributed over the surface of the macrostructure approximating a normal distribution having a standard deviation of 38 nanometers.

In one embodiment of the invention, the nano-nodules preferably cover greater than 95% of the surface area of the macrostructures. It has been found that the amount of surface area coverage is an important determining factor in the exiting light distribution of the optical film. By-providing greater than 95% coverage, the viewing angle can be optimized for a given nano-nodule size, shape and macrostructure geometry. In another embodiment of the invention, the nano-nodules preferably cover between 65 and 85% of the macrostructure surface. By providing between 65% and 85% coverage, the optical film can have both redirecting and high viewing angle characteristics compared to a macrostructure that does not have any nano-nodules or a macro-structure that is has nano-nodules that cover greater than 95% of the surface area.

In a further embodiment of the invention, the surface opposite the light exit surface comprises nano-nodules. Nano-nodules on the surface opposite of the light exit surface provide additional light diffusion without significantly reducing the ability of the macrostructure to recycle low angle incident light. Nano-nodules on the side opposite the light exit surface also reduce visual defects in the optical film and create an optical stand-off when the optical film of the invention is contacted with other surfaces. Finally, the nano-nodules present of the side opposite the light exit surface provide an excellent conveyance surface form the optical film, reducing scratching and abrasion during manufacturing.

The optical film preferably comprises a film bearing convex macrostructures on the light exit surface wherein the macrostructures have a length, diameter, or other major dimension of at least 25 micrometers and wherein the surfaces of the macrostructures exhibit a Rₐ value of not more than 1200 nanometers. Roughness average or Rₐ means the average peak to valley height between nano-nodules and is measured in by a profilometer and the result is expressed in nanometers. By providing macrostructures having a Rₐ less than 1200 the optical film provides both high brightness and a wide viewing angle. Macrostructures having an average diameter greater than 1500 nanometers reduces the amount of collimation resulting in an unwanted reduction in the overall brightness of the film;

In another embodiment of the invention, the Ra value of the surface macrostructures is between 600 and 1000 nanometers. It has been found that a macrostructure having a surface roughness average between 600 and 1000 nanometers provides both collimation and wide viewing angles that are suitable for LCD TV applications.

The size, shape and the distribution of the macrostructure are important in determining the distribution of light exiting the macrostructures. Macrostructures having an aspect ratio of between 0.5 and 6.0 are preferred. Macrostructures with an aspect ratio less than 0.2 tend to have a small influence on increasing on-axis gain. Macrostructures with an aspect ratio of greater than 6.0 are difficult to form utilizing melted polymer cast against patterned metallic roller as the polymer tends to adhere to the surface of high aspect ratio features. Further, high pressure is required to fully form the high aspect ratio features significantly reducing tool life.

In one embodiment of the invention the macrostructures have a repeating pattern. Repeating patterns generally provide low amounts of undesirable un-patterned area because repeating patterns have a relative high packing density compared to random macrostructures. In another embodiment of the invention, the macrostructures have a random pattern. While the random pattern does generally result in some un-patterned optical film because of the lower packing density compared to repeating patterns, a random pattern does generally result in lower levels of Moiré compared to repeating patterns. A random pattern has also been shown to hide or obscure small film defects from the viewer eye.

In another embodiment of the invention, the macrostructures have a length, diameter or other dimension of at least 100 micrometers. A microstructure having a dimension greater than 100 micrometers provides the desired collimation for incident light required to provide an on-axis gain greater than 1.0. Further, microstructures that do not have a dimension greater than 100 micrometers are more difficult to manufacture and because of there size can result in unwanted un-patterned area on the optical film.

Light collimation macrostructures generally reject incident light at off axis angles and allow at or near on-axis to be transmitted. Typically, a plot of angle vs. luminance for a collimation macrostructure shows a peak luminance at or near 0 degree followed by a reduction in luminance as the angle approaches 90 degrees. The slope of the luminance reduction is a function of macrostructure geometry. It has been found that by providing a roughness on the surface of the macrostructures that the change in slope can be dramatically altered to provide increased luminance over a wider range of angles. In a preferred embodiment of the invention, an optical film comprising a film bearing convex or concave macrostructures on the light exit surface wherein the macrostructures have a length, diameter, or other major dimension of at least 25 micrometers and wherein the surfaces of the macrostructures exhibit an Rₐ value low enough to provide a reduction in on-axis optical gain of at least 25% compared to the same macrostructure arrangement without the surface roughness is preferred. It has been found that a reduction in on-axis gain of at least 25% results in a desirable increase in luminance at off-angles compared to smooth macrostructures resulting in an optical film with improved luminance properties.

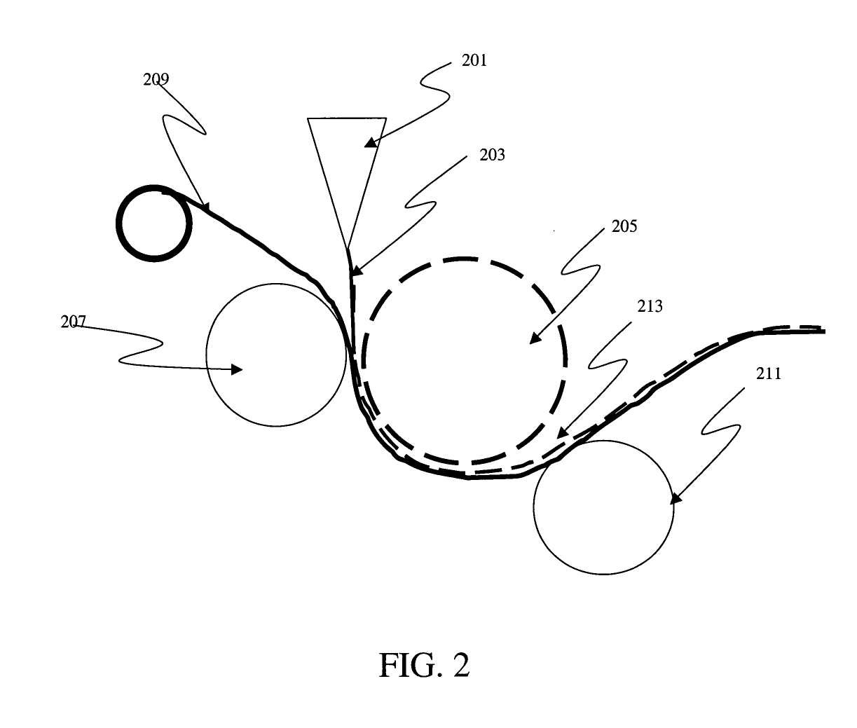

FIG. 2 is a simplified schematic diagram of an apparatus for fabricating the optical film such as described in connection with FIG. 3. The apparatus includes an extruder 201, which extrudes a material 203. The apparatus also includes a patterned roller 205 that contains macrostructures with nano-nodules that forms the optical features in the optical layer 213. Additionally, the apparatus includes a pressure roller 207 that provides pressure to force material 203 into patterned roller 205 and stripping roller 211 that aids in the removal of material 203 from patterned roller 205.

In operation, a base layer 209 is forced between the pressure roller 207 and the patterned roller 205 with the extruded material 203. In an example embodiment, the base layer 209 is an oriented sheet of polymer. Moreover, the material 203 forms the optical layer 213, which includes optical features after passing between the patterned roller 205 and the pressure roller 207. Alternatively, an adhesion layer may be co-extruded with the material 203 at the extruder 201. Co-extrusion offers the benefit of two or more layers. The co-extruded adhesion layers can be selected to provide optimum adhesion to the base layer 209 and the optical layer 213 creating higher adhesion than a mono-layer. Accordingly, the co-extruded adhesion and optical layers are forced with the base layer between the pressure roller 207 and the patterned roller 205. After passing between the pressure roller 207 and the patterned roller 205, a layer 213 is passed along a roller 211. In a specific embodiment, the layer 213 is an optical structure of the embodiments described in detail with respect to FIG. 3.

In another preferred embodiment, the material 203 comprises a co-extruded layer of polymer having a skin layer that contacts the nano-nodule pattered roller 205 that has a melt index that is 50% greater than the remaining layers in the co-extruded structure. It has been found that a high flow skin layer aids in the replication fidelity of the polymer. The layers other than the skin layer may have a much lower melt index, resulting in a mechanically stiffer optical film that is better suited to withstand the rigors of display devices.

The nano-nodule patterned roller preferably comprises a metallic roller containing the base macrostructures covered with the nano-nodules. The macrostructures may be machined or randomly deposited onto the surface of the roller. Known techniques such as diamond turning, bead blasting, coining, micro-indentation or electromechanical engravings have been shown to produce acceptable macrostructures. Preferably, nano-nodules are uniformly applied to the surface macrostructures machined into a metallic roller by means of precision electro-chemical deposition takes place in a fluoride bath to assure a positive, lasting bond between the base metal and the surface. The thin dense chrome is applied electrolytically, resulting in a bond superior to platings or coatings applied without the use of electricity (i.e. electroless nickel, etc.). A minimum deposition thickness of 0.25 micrometers prevents hydrogen build-up that often plagues electro-chemical plating. Thin, dense nodular chrome is hard chrome, which is so thin it has not yet built up enough stress to cause cracking, and therefore has good corrosion resistance. It uniformly deposits a dense, high-chromium, non-magnetic alloy on the surface of the metallic macrostructures. Additionally, The thin dense nodular chrome has been shown to increase lubricity, prevents galling, improve wear resistance, have a lower coefficient of friction, provides excellent anti-seizure characteristics and has lower corrosion resistance compared to metallic macrostructures without the addition of the thin dense nodular chrome.

The thin dense chrome plating of the macrostructures can be applied in thickness ranges from 0.25 micrometers to 4.0 micrometers. Thicker application of the thin dense chrome to the macrostructures has been found to increase the nano-nodule diameter and reduce on-axis brightness of the optical film. The thin dense chrome deposition preferably takes place at low temperatures, generally less than 60 degrees C., and is applicable to all ferrous and nonferrous metals without causing distortion. Precise control of thickness tolerances is achieved by careful fixturing of the parts and control of the plating bath. Also, the nodular thin dense chrome plating exhibits no undesirable build-up on corners or sharp edges. It has been found that the nano-nodules follow the contours of the macrostructure of the base metal with accurate deposit thickness thus creating very uniform nodulization of the macrostructure.

In a preferred embodiment of the invention, the thin dense nano-nodules are applied patter-wise to the surface of the macrostructures. The pattern-wise deposition of the nano-nodules can be accomplished by masking the portions of either the roller or the individual macrostructures such that the nano-nodules are not present on the surface of either a portion of the roller or desired areas of the individual macrostructures. Pattern-wise applied nano-nodules can also preferably be applied in a gradient over the macrostructures or over a larger area corresponding to margin and center areas of a LCD display.

As applied in the thin dense nodular chrome process, the coating's hardness value is in the range of 70 to 80 Rockwell C. By providing hardness between 70 to 80 Rockwell C, a softer, easier to machine base metal (induction hardened steel, for example, measures at 62 on the Rockwell C scale) can be utilized in the formation of the macrostructures. Add to this, the natural lubricity of chromium, and you have an outstanding coating for reducing wear and friction, preventing galling and seizing, and improving mold release of the polymer cast against the patterned roller.

The nano-nodules may also be applied to the surface of the macrostructures by means known in the art such as bead blasting, sand blasting, micro-abrasion or micro-indentation.

In another preferred embodiment of the invention, an optical device comprising a film bearing convex or concave macrostructures on the light exit surface wherein the macrostructures having a length, diameter, or other major dimension of at least 25 micrometers, a major portion of the macrostructure surfaces being covered with nano-nodules having an average diameter size less than 1200 nm is preferred. The device preferably comprises a display device that utilizes light management films to change the direction of incident light to enhance the quality or nature of the display. Preferred devices include, but not limited to LCD, OLED, projection display, plasma display, and PLED.

The invention may be used in conjunction with any liquid crystal display devices, typical arrangements of which are described in the following. Liquid crystals (LC) are widely used for electronic displays. In these display systems, an LC layer is situated between a polarizer layer and an analyzer layer and has a director exhibiting an azimuthal twist through the layer with respect to the normal axis. The analyzer is oriented such that its absorbing axis is perpendicular to that of the polarizer. Incident light polarized by the polarizer passes through a liquid crystal cell is affected by the molecular orientation in the liquid crystal, which can be altered by the application of a voltage across the cell. By employing this principle, the transmission of light from an external source, including ambient light, can be controlled. The energy required to achieve this control is generally much less than that required for the luminescent materials used in other display types such as cathode ray tubes. Accordingly, LC technology is used for a number of applications, including but not limited to digital watches, calculators, portable computers, electronic games for which light weight, low power consumption and long operating life are important features.

Active-matrix liquid crystal displays (LCDs) use thin film transistors (TFTs) as a switching device for driving each liquid crystal pixel. These LCDs can display higher-definition images without cross talk because the individual liquid crystal pixels can be selectively driven. Optical mode interference (OMI) displays are liquid crystal displays, which are “normally white,” that is, light is transmitted through the display layers in the off state. Operational mode of LCD using the twisted nematic liquid crystal is roughly divided into a birefringence mode and an optical rotatory mode. “Film-compensated super-twisted nematic” (FSTN) LCDs are normally black, that is, light transmission is inhibited in the off state when no voltage is applied. OMI displays reportedly have faster response times and a broader operational temperature range.

Ordinary light from an incandescent bulb or from the sun is randomly polarized, that is, it includes waves that are oriented in all possible directions. A polarizer is a dichroic material that functions to convert a randomly polarized (“unpolarized”) beam of light into a polarized one by selective removal of one of the two perpendicular plane-polarized components from the incident light beam. Linear polarizers are a key component of liquid-crystal display (LCD) devices.

There are several types of high dichroic ratio polarizers possessing sufficient optical performance for use in LCD devices. These polarizers are made of thin sheets of materials, which transmit one polarization component and absorb the other mutually orthogonal component (this effect is known as dichroism). The most commonly used plastic sheet polarizers are composed of a thin, uniaxially stretched polyvinyl alcohol (PVA) film, which aligns the PVA polymer chains in a more-or-less parallel fashion. The aligned PVA is then doped with iodine molecules or a combination of colored dichroic dyes (see, for example, EP 0 182 632 A2, Sumitomo Chemical Company, Limited), which adsorb to and become uniaxially oriented by the PVA to produce a highly anisotropic matrix with a neutral gray coloration. To mechanically support the fragile PVA film it is then laminated on both sides with stiff layers of triacetyl cellulose (TAC), or similar support.

Contrast, color reproduction, and stable gray scale intensities are important quality attributes for electronic displays, which employ liquid crystal technology. The primary factor limiting the contrast of a liquid crystal display is the propensity for light to “leak” through liquid crystal elements or cell, which are in the dark or “black” pixel state. Furthermore, the leakage and hence contrast of a liquid crystal display are also dependent on the angle from which the display screen is viewed. Typically the optimum contrast is observed only within a narrow viewing angle centered about the normal incidence to the display and falls off rapidly as the viewing angle is increased. In color displays, the leakage problem not only degrades the contrast but also causes color or hue shifts with an associated degradation of color reproduction. In addition to black-state light leakage, the narrow viewing angle problem in typical twisted nematic liquid crystal displays is exacerbated by a shift in the brightness-voltage curve as a function of viewing angle because of the optical anisotropy of the liquid crystal material.

The optical film of the present invention can even out the luminance when the film is used as a light-scattering film in a backlight system. Back-lit LCD display screens, such as are utilized in portable computers, may have a relatively localized light source (ex. fluorescent light) or an array of relatively localized light sources disposed relatively close to the LCD screen, so that individual “hot spots” corresponding to the light sources may be detectable. The diffuser film serves to even out the illumination across the display. The liquid crystal display device includes display devices having a combination of a driving method selected from e.g. active matrix driving and simple matrix drive and a liquid crystal mode selected from e.g. twist nematic, supertwist nematic, ferroelectric liquid crystal and antiferroelectric liquid crystal mode, however, the invention is not restricted by the above combinations. In a liquid crystal display device, the oriented film of the present invention is necessary to be positioned in front of the backlight. The optical film of the present invention can even the lightness of a liquid crystal display device across the display because the film has excellent light-scattering properties to expand the light to give excellent visibility in all directions. Although the above effect can be achieved even by the single use of such film, plural number of films may be used in combination. The homogenizing film may be placed in front of the LCD material in a transmission mode to disburse the light and make it much more homogenous.

The present invention has a significant use as a light source destructuring device. In many applications, it is desirable to eliminate from the output of the light source itself the structure of the filament which can be problematic in certain applications because light distributed across the sample will vary and this is undesirable. Also, variances in the orientation of a light source filament or arc after a light source is replaced can generate erroneous and misleading readings. A homogenizing film of the present invention placed between the light source and the detector can eliminate from the output of the light source any trace of the filament structure and therefore causes a homogenized output which is identical from light source to light source.

The optical film may be used to control lighting for stages by providing pleasing homogenized light that is directed where desired. In stage and television productions, a wide variety of stage lights must be used to achieve all the different effects necessary for proper lighting. This requires that many different lamps be used which is inconvenient and expensive. The films of the present invention placed over a lamp can give almost unlimited flexibility dispersing light where it is needed. As a consequence, almost any object, moving or not, and of any shape, can be correctly illuminated.

A reflection film can be formed by applying a reflection layer composed of a metallic film, etc., to the light exit surface of the optical film of the present invention and can be used e.g. as a retroreflective member for a traffic sign. It can be used in a state applied to a car, a bicycle, person, etc.

The optical film of the present invention may also be used in the area of law enforcement and security systems to homogenize the output from laser diodes (LDs) or light emitting diodes (LEDs) over the entire secured area to provide higher contrasts to infrared (IR) detectors. The films of the present invention may also be used to remove structure from devices using LED or LD sources such as in bank note readers or skin treatment devices. This leads to greater accuracy.

Fiber-optic light assemblies mounted on a surgeon's headpiece can cast distracting intensity variations on the surgical field if one of the fiber-optic elements breaks during surgery. A optical film of the present invention placed at the ends of the fiber bundle homogenizes light coming from the remaining fibers and eliminates any trace of the broken fiber from the light cast on the patient. A standard ground glass diffuser would not be as effective in this use due to significant back-scatter causing loss of throughput.

The optical films of the present invention can also be used to homogeneously illuminate a sample under a microscope by destructuring the filament or arc of the source, yielding a homogeneously illuminated field of view. The films may also be used to homogenize the various modes that propagate through a fiber, for example, the light output from a helical-mode fiber.

The optical films of the present invention also have significant architectural uses such as providing appropriate light for work and living spaces. In typical commercial applications, inexpensive transparent polymeric diffuser films are used to help diffuse light over the room. A homogenizer of the present invention, which replaces one of these conventional diffusers, provides a more uniform light output so that light is diffused to all angles across the room evenly and with no hot spots.

The optical films of the present invention may also be used to diffuse light illuminating artwork. The transparent polymeric film diffuser provides a suitable appropriately sized and directed aperture for depicting the artwork in a most desirable fashion.

Further, the optical film of the present invention can be used widely as a part for optical equipment such as a displaying device. For example, it can be used as a light-reflection plate laminated with a reflection film such as a metal film in a reflective liquid crystal display device or a front scattering film directing the film to the front-side (observer's side) in the case of placing the metallic film to the back side of the device (opposite to the observer), in addition to the aforementioned light-scattering plate of a backlight system of a liquid crystal display device. The optical film of the present invention can be used as an electrode by laminating a transparent conductive layer composed of indium oxide represented by ITO film. If the material is to be used to form a reflective screen, e.g. front projection screen, a light-reflective layer is applied to the transparent polymeric film diffuser.

Another application for the optical film is a rear projection screen, where it is generally desired to project the image from a light source onto a screen over a large area. The viewing angle for a television is typically smaller in the vertical direction than in the horizontal direction. The optical film acts to spread the light to increase viewing angle.

Embodiments of the invention may provide not only improved light diffusion and collimation but also an optical film of reduced thickness, that has reduced light absorption tendencies, that exhibits a soft angular cut-off, or that exhibits reduced Moiré or Newton's Rings in an LCD display system.

The invention has been described in detail with particular reference to certain preferred embodiments thereof, but it will be understood that variations and modifications can be effected within the spirit and scope of the invention.

### EXAMPLE

In this example, nano-nodules were applied to the surface of a light redirecting macrostructure having a 90-degree apex angle to create a optical film having wide angular light distribution while minimizing light scatter. The light output of the redirecting macrostructure having nano-nodules applied to the surface were compared to a prior LCD grade light diffuser and a LCD grade light redirecting film.

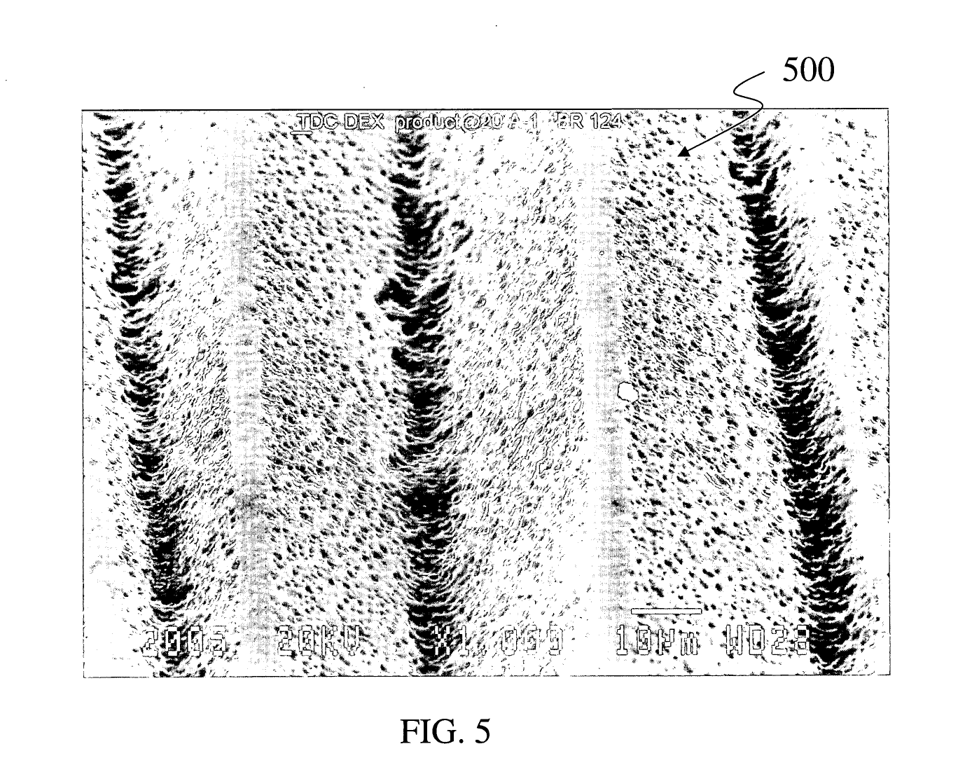

A metallic roller coated with high temperature nickel was electro-mechanically engraved with individual macrostructures having a 90 degree apex angle. The individual elements had a maximum depth of 35 micrometers a width of 40 micrometers and a length of 1200 micrometers. The electromechanically engraved nickel coated metallic roller was thin dense chrome platted and nano-nodules were formed on the surface of the electro-mechanically engraved macrostructures. FIG. 5 is a top view of the individual optical elements having nano-nodules on the surfaces of the individual elements. The Rₐ of the nano-nodules in FIG. 5 was 823 nanometers and the nano-nodules in FIG. 5 have a measured mean diameter of 942 nanometers. The nano-nodules are distributed log-normally over the surface of the nano-nodules having a median of 802 nanometers. As expected, the valley areas of FIG. 5 have higher density of nano-nodules that does the planner areas of the macrostructure because of the tendency of the nodule growth is toward shape peaks. It is understood that by reducing the sharp peaks of the macrostructures that a more uniform deposit of nano-nodules over the surface of the macrostructures can be achieved.

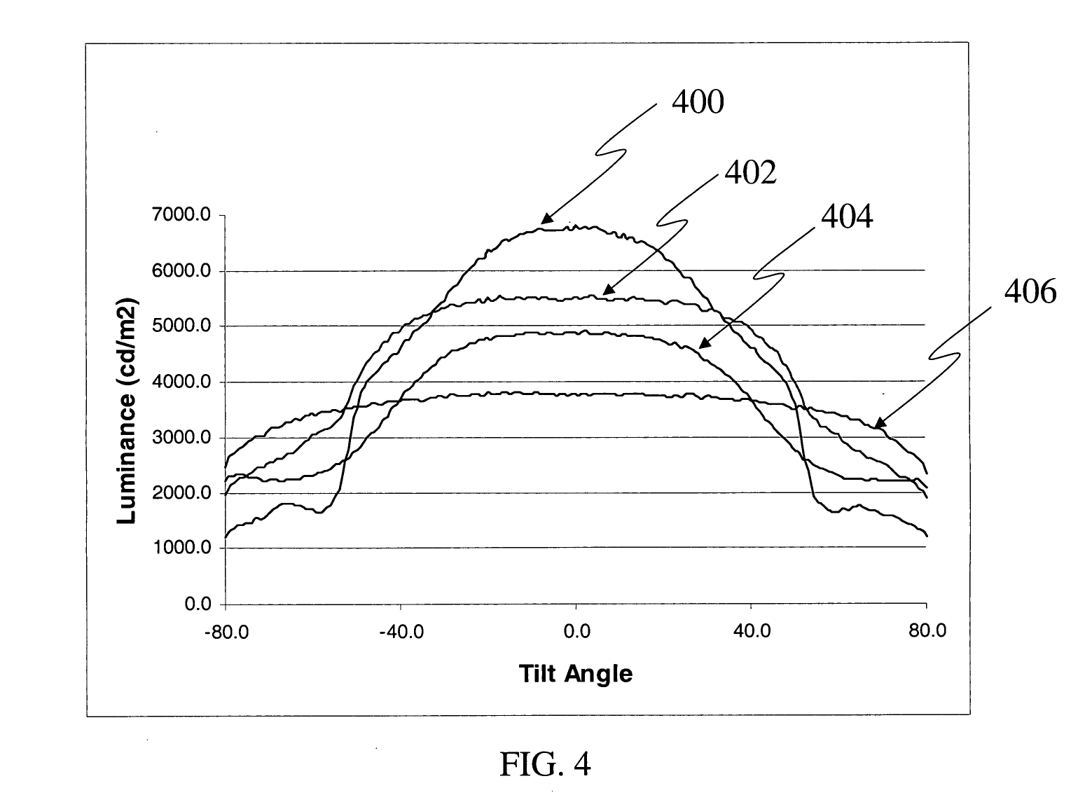

FIG. 4 is a plot of tilt angle vs. luminance for two prior art optical films (400 and 404) compared to the example, 402. The measurements of luminance were performed on an ELDIM. The control and feature films were measured on a 50 cm diagonal LCD TV rear illuminated backlight containing 12 CCFL bulbs. A LCD grade volume diffuser was placed over the CCFL bulbs and utilized in the ELDIM measurements. Curve 406 is the measured output of the volume diffuser utilized in the measurements. Curve 400 represents the measured values for a standard brightness enhancement film utilized to improve the on-axis brightness of typical LCD displays. While the curve 400 does have a high on axis brightness, the slope of the curve off axis (zero degree tilt angle) is large which can result in a loss in brightness of a LCD display device at angles off axis and reduce color saturation off axis. Curve 404 represents the measured values for a standard TV diffuser utilized to diffuse light from TV backlights. While the diffuser 404 does diffuse the backlight source by scattering the incident light energy, diffuser 404 does not have a sufficiently high on axis brightness, as typical LCD light diffusers tend to scatter transmitted light.

Curve 402 represents the measured values for the macrostructure covered with nano-nodules shown in FIG. 5. The wide angle collimation film 402 possess both a high on-axis gain and small slope off axis, allowing the invention material to diffuse illumination light source, provide a high on-axis brightness gain and provide relatively constant illumination over a wider range of tilt angles compared to brightness film 400. Curve 402 is representative of a collimated beam of incident light such that the intensity of the scattered light verse tilt angle over a desired angular width is substantially flat.

### PARTS LIST

2 Macrostructure
201 Extruder
203 Extruded material
205 Patterned roller
207 Pressure roller
209 Base layer
211 Stripping roller
213 Optical layer
300 Nano-nodules
400 Prior art film curve
402 Inventive film
404 Prior art film
406 Unmodified light output
500 Nano-nodules

1. A light redirecting optical device comprising a polymeric film containing a light entry and a light exit surface and bearing on the light exit surface convex macrostructures that have a length, diameter, or other major dimension of at least 25 micrometers, wherein a major portion of the macrostructure surfaces is covered with nano-nodules having an average maximum cord length in a plane perpendicular to the direction of light travel of less than 1200 nm.

2. The device of claim 1 wherein the nano-nodules have an average diameter size between 400 and 1200 nm.

3. The device of claim 1 wherein the nano-nodules have an average diameter size between 600 and 1000 nm.

4. The device of claim 1 wherein the nano-nodules are concave.

5. The device of claim 1 wherein the nano-nodules are convex.

6. The device of claim 1 wherein the macro-structures comprise a prism.

7. The device of claim 1 wherein the nano-nodules comprise polymer

8. The device of claim 1 wherein the nano-nodules are integral to the macro-structures.

9. The device of claim 1 wherein the macro-structures comprise individual optical elements.

10. The device of claim 1 wherein the macrostructures have a height to width aspect ratio between 0.5 and 5.0.

11. The device of claim 1 wherein the optical gain of the optical film is between 1.15 and 1.30.

12. The device of claim 1 wherein the nano-nodules are integral to the macro-structures and cover between 40 and 60% of the surface area of the macrostructures.

13. The device of claim 1 wherein the nano-nodules are randomly distributed over the surface of the macro-structures and the diameter of the nano-nodules overlap by at least 5%.

14. The device of claim 1 wherein the nano-nodules cover greater than 95% of the macro-structure surface.

15. The device of claim 1 wherein the nano-nodules cover between 65 and 85% of the macro-structure surface.

16. The device of claim 1 further comprising nano-nodules on a surface opposite the light exit surface.

17. An optical film comprising a film bearing convex macrostructures on the light exit surface wherein the macrostructures have a length, diameter, or other major dimension of at least 25 micrometers and wherein the surfaces of the macrostructures exhibit a Rₐ value of not more than 1200 nanometers.

18. The optical film of claim 17 wherein the Rₐ value of the surface of the macro-structures is between 600 and 1000 nanometers.

19. The optical film of claim 17 wherein the macrostructures have a height to width aspect ratio between 0.5 and 5.0.

20. The optical film of claim 17 wherein the macrostructures have a repeating pattern.

21. The optical film of claim 17 wherein the macrostructures have a length, diameter, or other major dimension of at least 100 micrometers.

22. An optical film comprising a film bearing convex or concave macrostructures on the light exit surface wherein the macrostructures have a length, diameter, or other major dimension of at least 25 micrometers and wherein the surfaces of the macrostructures exhibit an Rₐ value low enough to provide a reduction in on-axis optical gain of at least 25% compared to the same macrostructure arrangement without the surface roughness.

23. The optical film of claim 22 wherein the reduction in optical gain is between 37 and 63%.

24. The optical film of claim 22 wherein a major portion of the macrostructure surfaces being covered with nano-nodules having an average maximum cord length in a plane perpendicular to the direction of light travel of less than 1200 nm.

25. The optical film of claim 22 wherein the macrostructures have a height to width aspect ratio between 0.5 and 5.0.

26. A process for making a metal form comprising a surface having a morphology of macrostructures comprising the steps of electro-mechanically engraving on the surface of the metal form and plating the surface of the metal form to provide a metallic nano-nodule coating on the surface of the macrostructures.

27. The process of claim 26 wherein the macrostructure has an apex angle between 88 and 92 degrees.

28. The process of claim 26 wherein the metallic coating comprises thin dense chrome.

29. The process of claim 26 wherein the thickness of the metallic nano-nodule coating is between 0.25 and 4.0 micrometers.

30. The process of claim 26 wherein the form comprises metallic copper.

31. The process of claim 26 wherein the metallic nano-nodule coating has a mechanical hardness between 70 to 80 Rockwell C.
